(19) United States
(12) Patent Application Publication
(10) Pub. No.: US 2013/0290087 A1
(43) Pub. Date: Oct. 31, 2013

(54) METHOD OF IMPLEMENTING A LOYALTY AWARD PROGRAM

(71) Applicants: STEPHEN MERWARTH, Cumming, GA (US); Haven Brock Kolls, Alpharetta, GA (US)

(72) Inventors: STEPHEN MERWARTH, Cumming, GA (US); Haven Brock Kolls, Alpharetta, GA (US)

(21) Appl. No.: 13/456,050

(22) Filed: Apr. 25, 2012

(51) Int. Cl. G06Q 30/02

(52) U.S. Cl. 705/14.27

(57) ABSTRACT

The present invention relates to a system and method of implementing a loyalty awards program. The a loyalty award program can be implemented using tokenized user account data (e.g., credit card number, bank routing number, etc.) in lieu of original the account data. Using the tokenized data, the loyalty account can be identified and a loyalty award, based on purchase details of a transaction, can be associated with the user's account. The present invention does not require the loyalty system to be PCI compliant since the secure user account data is not handled and/or data warehoused at the loyalty system.

### TRADEMARKS

COCA-COLA® is a registered trademark of The Coca-Cola Company, Atlanta, Ga., U.S.A. Other names used herein may be registered trademarks, trademarks or product names of The Coca-Cola Company or other companies.

### TECHNICAL FIELD OF THE INVENTION

The present disclosure relates generally to implementing a loyalty awards program, and particularly to processing a purchase transaction tied to a loyalty rewards program.

### BACKGROUND OF THE INVENTION

As a way to retain customers and increase sales, several companies utilize consumer loyalty programs. Loyalty programs typically provide a customer a discount on their purchase or tie some type of points/award to their transaction. Traditional loyalty programs have been implemented using some form of a loyalty card used to identify the customer as a member of the loyalty program. Except in the case of retailer-issued credit cards which generally tie marketing and loyalty programs to the customer's credit account, a loyalty card is typically separate from any form of payment. Data from the card is scanned or entered prior to the transaction. The credit card industry requires companies that handle financial transactions to operate computer systems in accordance with the Payment Card Industry (PCI) Data Security Standards. Because many loyalty processing systems do not typically incorporate a credit card transaction into identifying a consumer's loyalty account they have not been designed to be PCI compliant. As such, it can be difficult to use credit card information as part of a loyalty program. This prevents basing loyalty awards on credit card purchases alone without the use of a loyalty card and, more specifically, basing loyalty awards on the purchase details associated with the credit card transaction.

One conventional approach to associating a purchased product with users has been to place codes on products and allow users to enter codes online, e.g., at a loyalty program website, as a way to indicate what products have been acquired. However, this additional step of customer-entered codes discourages many customers from participating in these types of programs. Another shortcoming to product code programs is that only goods can be tracked, not services. There is also no way to track data ancillary to the purchase. For example, there is no way to know when and where the product was purchased, who purchased the product, and who consumed the product. In addition, placing codes on products is expensive and can be cost prohibitive. Currently, codes on products are not available on dispensed product such as fountain beverages from quick serve restaurants and other establishments.

Conventional loyalty programs also struggle to remain relevant to a user because the awards offered are not tailored to the user's preferences. Failure to meet user expectation can result in a user signing up and then quickly dropping out of the program due to lack of interest. Current loyalty systems are not easily accessible, require multiple steps on the consumer to participate, such as entering product codes, and/or fail to set award levels and offer desirable awards to sustain user attention. Therefore, a need in the art exists for systems and methods that overcome one or more of the above-described limitations.

### SUMMARY OF THE INVENTION

The present invention is directed to a computer implemented method of implementing a loyalty awards program in a loyalty system. The method comprising presenting, at a user interface, a loyalty program enrollment form for receiving data from a user and receiving user data associated with the enrollment form. The method further comprising creating a loyalty account based on the user data, receiving tokenized account data associated with the user, and associating the tokenized account data with the loyalty account.

Another aspect of the present invention provides a computer implemented method of implementing a loyalty awards program. The method comprising receiving a tokenized account data and identifying a loyalty account associated with a user based on the tokenized account data. The method further comprising determining an loyalty award balance of the loyalty account, receiving a purchase request corresponding to an attempted user purchase event, and comparing the loyalty award balance to the purchase request to authorize a payment of a first loyalty award amount. The method further comprising posting a loyalty award amount to the loyalty account.

Another aspect of the present invention provides a computer implemented method of a loyalty awards program. The method comprising receiving a tokenized account data, searching a plurality of loyalty accounts at the loyalty system to identify a loyalty account associated with the tokenized account data, and creating a first loyalty account based on the tokenized account data when the loyalty account associated with the tokenized account data is not included in the loyalty system.

Another aspect of the present invention provides a computer implemented method for processing a loyalty award transaction comprising receiving user account data from a transaction device and providing the account data to an account processing system. The method further comprising tokenizing the user account data to create a tokenized user account data and providing the tokenized user account data to a loyalty system. The method further comprising providing instructions to a transaction device to complete a transaction, wherein the transaction is completed using at least one of the tokenized user account data and a loyalty award amount.

### BRIEF DESCRIPTION OF THE FIGURES

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram depicting an operating environment implementing a loyalty award program in accordance with certain exemplary embodiments;

FIG. 2 is a flow chart depicting a method of implementing a loyalty award program in accordance with certain exemplary embodiments;

FIG. 3A is a flow chart depicting a method of implementing a loyalty award program in accordance with certain exemplary embodiments;

FIG. 3B is a flow chart depicting a method of implementing a loyalty award program in accordance with certain exemplary embodiments.

### DETAILED DESCRIPTION OF THE INVENTION

The present disclosure provides a system and method of implementing a loyalty awards program. In an exemplary embodiment, a loyalty system can be implemented that utilizes tokenized account data in lieu of original account data. An advantage of the present invention is that the loyalty account can be identified and the loyalty award can be based on account data transaction, such as a credit card transaction and the purchase details of the transaction, while not requiring the loyalty system to be PCI compliant because the account data, such as credit card data, is not handled and/or data warehoused at the loyalty system.

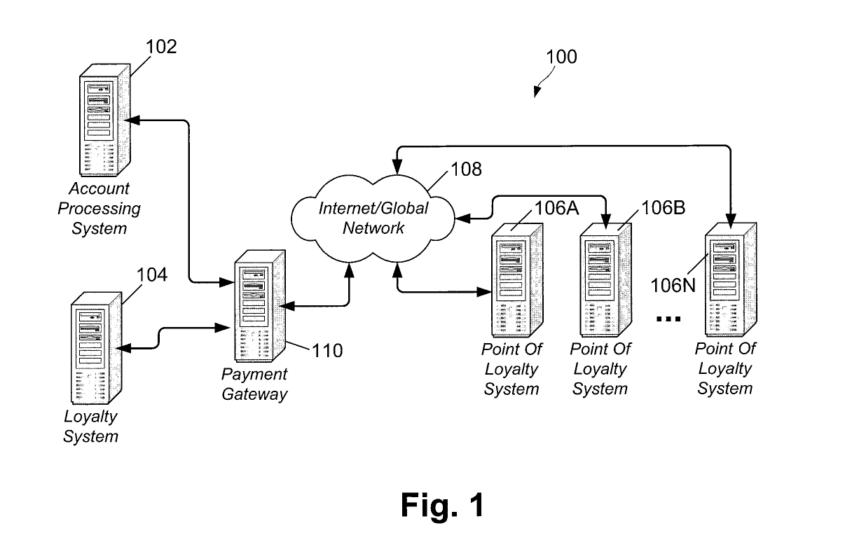

FIG. 1 illustrates the main components of the operating environment 100 for a loyalty award system in accordance with certain exemplary embodiments. The operating environment 100 can include an account processing system 102, a loyalty system 104, a payment gateway 110, and a plurality of point-of-loyalty systems 106A-106N, each communicating across a global network 108. While certain embodiments are described in which parts of the loyalty award system are implemented in software, it will be appreciated that one or more acts or functions of the loyalty award system may be performed by hardware, software, or a combination thereof, as may be embodied in one or more computing systems. For example, the account processing system 102, loyalty system 104, point-of-loyalty system 106, and payment gateway 110, can be embodied as stand alone application programs or as a companion program to a web browser having messaging and storage capabilities.

In an exemplary embodiment, the account processing system 102, loyalty system 104, payment gateway 110, and point-of-loyalty system 106, and/or other data processing resources as may be required, can communicate over the network 108. The network 108 includes a wired or wireless communication system or device by which network devices (including account processing system 102, loyalty system 104, payment gateway 110, and point-of-loyalty system 106) can exchange data. For example, the network 108 can include a telecommunications network, a local area network (LAN), a wide area network (WAN), an intranet, an Internet, or any combination thereof. In an exemplary embodiment, the communication between the account processing system 102, loyalty system 104, payment gateway 110, and point-of-loyalty system 106 can be encrypted to protect and secure the data communication between the systems. It will be appreciated that the network connections disclosed are exemplary and other means of establishing a communications link between the including account processing system 102, loyalty system 104, payment gateway 110, and point-of-loyalty system 106 can be used.

The exemplary operating environment 100 includes a loyalty system 104 for implementing the loyalty award accounts associated with users of the environment 100. An exemplary loyalty award program operated using loyalty system 104 can include COCA-COLA'S MY COKE REWARDS consumer loyalty program. An exemplary loyalty system 104 can provide a user interface for collecting and displaying data relevant to user's loyalty award accounts. In an exemplary embodiment, the loyalty system 104 is configured to create, collect, manage, and modify information associated with user loyalty award accounts. Information associated with a loyalty award account can include, for example, user-specific identification information, tokenized account information, user purchase information, historical user information, a loyalty award amount, and other information necessary for implementing the loyalty award system.

In an exemplary embodiment, the user identification information stored to the loyalty system 104 can include a user's personal information, such as, name, address, age, gender, demographic information, email address, telephone number, system preferences, use of a mobile application associated with the loyalty award system, social media profile, instant messaging profile, etc. In an exemplary embodiment, the tokenized account information stored to the loyalty system 104 can include a tokenized version of an identifier associated with the user's account data. In an exemplary embodiment, the user purchase information stored to the loyalty system 104 can include a user's purchase history information, user product preferences, user award accumulation based on product purchases, etc. In an exemplary embodiment, the historical user information stored to the loyalty system 104 can include, for example, the user's award history. In an exemplary embodiment, the loyalty award amount stored to the loyalty system 104 can be an award designation amount comparable to some monetized value, purchase history (quantity, location, purchase in response to promotion, etc.), or other interaction with the loyalty system 104. For example, the loyalty award amount can consist of “points” awarded to the user in response to the purchase of a particular product, or points earned through completing various tasks associated with the loyalty award system, e.g., “liking” or “tagging” the loyalty award program on a social media site. The loyalty award amount can be a fixed award or a dynamic award based on the goods or service the user obtained, the frequency of purchase, establishments visited, and/or other factors relevant to implementing the loyalty reward system.

In an exemplary embodiment, the loyalty system 104 is configured to register users, create/update user loyalty award accounts, and/or update profile information associated with a user's account. A user can input, capture, view, download, upload, edit, and otherwise access and manipulate the information included in their loyalty award account using the loyalty system 104. In an exemplary embodiment, the loyalty system 104 can host a website that enables the user to register and interact with the loyalty system 104. For example, users can enroll in the loyalty awards program and create a registered loyalty award account by completing a web-based form provided by the loyalty system 104. The web-based form can request the information necessary to create the loyalty award account. For example, the web-based form can include fields for the user to provide user-specific identification information, tokenized account information, user purchase information, historical user information, a loyalty award amount, and other information necessary for the administration of the loyalty award program.

In an exemplary embodiment, the loyalty system 104 can request account data from the user. For example, the web-based form can include a field asking the user to enter their account data, such as a credit card number, payment card, or other payment account, they wish to associate with the loyalty account being created. As used throughout this disclosure, account data can include, for example, credit card data, personal payment information, bank account routing information, personal identification data, digital wallet (RFID) payment account information, stored value card such as a store gift card, employee badges, hotel room key cards, loyalty program award cards, frequent flier/hotel/guest/other and/or other frequent user cards, and/or other account data, as may be required and/or desired to process a consumer transaction.

In an exemplary embodiment, the loyalty system 104 is PCI complaint and storage/use of the account data at the loyalty system 104 is acceptable based on PCI security standards. In another exemplary embodiment, the loyalty system 104 is not PCI compliant and storage of user account data at the loyalty system 104 is not permitted under PCI security standards. In such an embodiment, the account data is tokenized at the payment gateway 110 communicated with the account processing system 102. For example, in the embodiment involving a web-based form including an account data field, the account data field, though presented to the user as part of the loyalty system's 104 enrollment form, is actually controlled and provided by the payment gateway 110. In an exemplary embodiment, when a user selects to include account information with their registered loyalty account a pop-up window can open and shift control of the form from the loyalty system 104 to the payment gateway 110. Because the payment gateway 110 is controlling and receiving the account information (e.g., user's credit card number), the loyalty system 104 does not receive the user's account information and does not need to be a PCI compliant system. Upon receiving the account information, the payment gateway 110 may tokenize, hash, or otherwise encrypt the account information as disclosed below. The payment gateway 110 can then pass the tokenized account information to the loyalty system 104 and pass control of the web-based form/website back to the loyalty system 104.

The loyalty system 104 can compare the tokenized account data to a database of including a plurality of tokenized account data to identify the corresponding loyalty account associated with the user's tokenized account data. In an exemplary embodiment, the loyalty system 104 can then associate the tokenized account information with the registered loyalty account. Once the loyalty account associated with the tokenized account data has been identified, a loyalty award can be posted to the loyalty account. Because the loyalty system 104 has not handled the account data and has only received tokenized account data, the loyalty system 104 is not required to be a PCI compliant system.

An exemplary operating environment 100 includes an account processing system 102. The account processing system 102 can include, for example, a transaction processing bureau, such as a credit card processor and/or other account processing system. An exemplary account processing system 102 can be a financial transaction processor and/or a bank including, for example, BANK OF AMERICA, HEARTLAND, VISANET, and/or other account processing systems, for processing a payment based on the user's account information received at the point-of-loyalty system 106. In an exemplary embodiment, the account data accepted at the point-of-loyalty system 106 for the purchase of goods or services is tokenized at the payment gateway 110 and communicated to the account processing system 102 for processing. The account processing system 102, using the account data, authorizes a user purchase transaction at the point-of-loyalty system 106. In some embodiments the account processing system 102 may use the tokenized account data in authorizing a user purchase transaction. In this regard, the payment for the purchased goods or services can be effectuated.

An exemplary operating environment 100 includes a payment gateway 110. In an exemplary embodiment, the payment gateway 110 is PCI complaint. The payment gateway 110 can receive account information from the account processing system 102 and/or the point-of-loyalty system 106 and tokenize, hash, or otherwise encrypt the account information in a repeatable manner to generate tokenized account information. In an exemplary embodiment, the payment gateway 110 can be a transaction switch or gateway including, for example, S1, TNS, ACI, FIRSTDATA, ELAVON, and/or other gateway for tokenizing user account information such as credit card information.

In an exemplary embodiment, mutually exclusive from the loyalty system 104, the payment gateway 110 tokenizes the account data and provides the tokenized account data to the loyalty system 104, point-of-loyalty system 106, and/or the account processing system 102. Because the loyalty system 104 and the point-of-loyalty system 106 receive only the tokenized account information, they are not required to be PCI compliant. Tokenization can be generally defined as the systematic replacing of a portion of a string of data by such corresponding “token.” That is, tokenization replaces the primary consumer account information (e.g., a credit card number) with a surrogate number. In an exemplary embodiment, the tokenization process can be completely destructive, which provides no possibility for the original card number to be reconstructed from the token. This process is commonly referred to hashing or creating a hash value. In the exemplary tokenization process, the string (account data) is replaced with a hashed encrypted token generated from the string (account data). In an exemplary embodiment, a one-way hash technique is used preventing later decryption. In an alternate embodiment, the tokenization may not be destructive to the original card number, providing a mechanism to obtain the original card number given the token. Those skilled in the area of payment processing may identify other forms of tokenization that would apply. As an alternative to tokenizing the account data, the account data (e.g., credit card number) may be encrypted. In an exemplary embodiment, the account data can be encrypted through one-way hashing algorithm.

The exemplary operating environment 100 includes a plurality of point-of-loyalty systems 106A-106N, wherein ‘N’ refers to some unknown number of a plurality of point-of-loyalty systems. An exemplary point-of-loyalty system 106 can be embodied as a credit card terminal, RFID payment terminal, or other terminal-type embodiments for completing a consumer transaction. Such terminal-type embodiments can be placed at cash registers and/or consumer payment locations throughout a retail establishment. In an exemplary embodiment, a point-of-loyalty system 106 can be placed at a vending machine, such as a COCA-COLA vending machine. Such terminal-type embodiments can alternatively be based in software or firmware and integrated into existing point-of-sale systems. For example, a point-of-loyalty system 106 can be a quick serve restaurant, theater, store, other retail establishment, online website, and/or other points of sale. Examples of quick serve restaurants include MCDONALD'S, BURGER KING, WENDY'S, FIRE HOUSE SUBS, etc. Examples of theatres include, for example, AMC, REGAL, live performance theaters, etc. Examples of stores or other retail establishments include, for example, WALMART, TARGET, KROGER, etc. Examples of online websites can be AMAZON.COM, EBAY.COM, EXPEDIA.COM, DISCOVERCARD.COM, VISA.COM, MASTERCARD.COM, etc. Other quick serve restaurants, theaters, retail establishments, online websites, and locations for point-of loyalty systems 106 as may be required and/or desired in a particular embodiment are also contemplated.

In addition to communicating the tokenized account data, the point-of-loyalty system 106 can also communicate purchase information to the loyalty system 104 and/or account processing system 102. As described above, purchase information can include the type, kind, and/or amount of a product or service that was purchased. Purchase information can also include, for example, what features of the point-of-loyalty system 106 the user utilized in completing their transaction. In an exemplary embodiment, the purchase data can include whether the user utilized any of the interactive features of the point-of-loyalty system 106, what items were considered by the user, what specialized data (e.g., nutritional information, pricing, etc.) the user requested/observed at the point-of-loyalty system 106. For example, when a user purchases good or services in the form of food and beverages such purchase detail is communicated with the tokenized account data to the loyalty system 104, that is, if a user purchases 32-ounces of a COCA-COLA product from a quick serve restaurant point-of-loyalty system 106, such transaction detail as the size and type of beverage purchased, the location of purchase, quantity or volume of the product purchased, frequency of user purchase of the same or similar item, etc., can be communicated with the tokenized account data as purchase data.

In an exemplary embodiment, the purchase information can be used by the loyalty system 104 to determine a dynamic loyalty award such as varied points amount based on volume of product consumed, or varied points amount based on the type or kind of product purchased, or varied promotional amount for certain products purchased during a promotional period, and/or other dynamic loyalty award awarded based on other criteria, as may be required and/or desired in a particular embodiment.

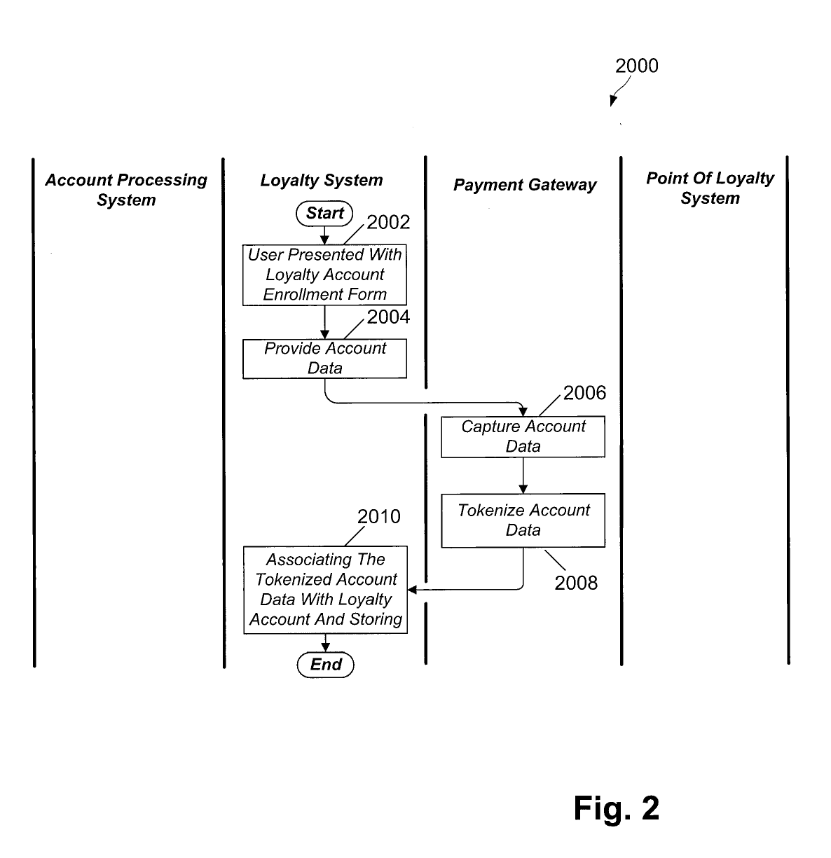

FIG. 2 is a flow chart depicting a method 2000 of implementing a loyalty award program, wherein a user can register a new loyalty account at the loyalty system 104, in accordance with certain exemplary embodiments. To initiate the enrollment process, a user is presented with a loyalty account enrollment form or is able to update an existing user profile at the loyalty system 104. (Step 2002). In an exemplary embodiment, enrollment form and/or profile update can be internet accessible from the loyalty system 104 and presented to the user via a web-based form.

In an exemplary embodiment, the web page being displayed by the loyalty system 104 can comprise an account input field. Such an account information field allows the user to input account information, such as a credit card number that when later used at a point-of-loyalty system 106 will indirectly serve to identify the user's loyalty account and thereby allow loyalty awards to be posted to and redeemed from the user's loyalty account.

In an exemplary embodiment, in operation, though displayed to the user as part of the enrollment form, the account information field is not associated with the loyalty system 104. Rather, the account information field is associated with the payment gateway 110. In an exemplary embodiment, a pop-up window or new browser opens and shift control of the enrollment form from the loyalty system 104 to the payment gateway 110. As such, the user input to the account information field is not processed, stored or otherwise handled by the loyalty system 104. Such account information provided by the user is only known and accessible for processing to the payment gateway 110.

In an exemplary embodiment, since the loyalty system 104 does not process, store, or otherwise handle the account information, such as credit card or other secure user payment information, the loyalty system 104 is not required to be PCI compliant. In an alternate embodiment, the loyalty system 104 can be PCI compliant.

In an exemplary embodiment, account information including, for example, credit card data, is transformed to tokenized account information, by a separate payment gateway 110, which is PCI compliant and/or otherwise certified to process and handle financial data, mutually exclusive from the loyalty system 104, which can process and handle the account information. Such account payment gateway 110 provides an account information tokenization service and communicates to the loyalty system 104 the tokenized account information for association with the user's loyalty account.

The user provides account information in the account input field. (Step 2004). In an exemplary embodiment, the account information can be a credit card number, employee badge ID, hotel room key, personal identification, and/or other account data used to provide payment information. Such account information is being provided for the purpose of utilizing a payment gateway 110 to tokenize the account data. The tokenized data will be associated with the loyalty account and stored in the loyalty system 104. Future transactions at a plurality of points-of-loyalty systems 106A-106N may see the user present the same account data for payment of goods or services and using the tokenized account data, the loyalty system 104 can quickly identify the appropriate loyalty account.

In an exemplary embodiment, a vendor may compile transactions into a flat file containing the account information and the transaction details. The flat files can be compiled at regular intervals (e.g., hourly, daily) or as determined by the vendor. These flat files can be stored as batches at the point-of-loyalty system 106. The batch files can be sent to the payment gateway 110 where the payment gateway 110 will capture and tokenize the account data for all of the transactions included in the batch file. In an alternate embodiment, the vendor can tokenize the account information and save the tokenized account information and the transaction details in the batch files. Once the account information has been tokenized, either by the vendor or the payment gateway 110, the batch files are sent to the loyalty system 104. Using the batch files, the loyalty system 104 can match the tokenized account information, and the corresponding transaction details, with existing loyalty award accounts. Any unmatched tokenized account information may either be ignored or used to create a “light” loyalty account as described in more detail below. For example, a retail establishment may elect to process user purchase transactions during business hours and then at the end of the day, in one or more batches. The retail establishment can provide these batch files to the account processing system 102, the loyalty system 104, and the payment gateway 110, to effectuate payment for goods or services and the posting and/or redemption of loyalty awards. In an alternate exemplary embodiment, transactions can be processed in real-time with the posting and redemption of loyalty awards occurring simultaneously.

The account data entered into the account input field is captured by the payment gateway 110. (Step 2006). In an exemplary embodiment, the loyalty system 104 has no interaction with the entered and captured data and, as such, the loyalty system 104 does not need to be PCI compliant or otherwise compliant to handle financial information and/or account data such as credit card data. Though the account input field may appear to the user and/or be displayed as part of the loyalty account enrollment form or as part of a user profile update on the loyalty system 104, the account input field is configured, controlled, and processed by the payment gateway 110 and is mutually exclusive from the loyalty system 104, which is configured to gather and process other enrollment information not related to the account information.

In an exemplary embodiment, the account information is transformed into tokenized account data by the payment gateway 110. (Step 2008). Such tokenization can be effectuated by way of a one-way encryption algorithm such as a MD5 hash algorithm or other algorithm, as known in the relevant art. Using a one-way encryption algorithm, predictably each time the same account information is presented and tokenized the resultant tokenization account data is the same. However, starting with the tokenized information data there is no known algorithm that will decrypt or reconstruct the tokenized account information back into the original account information. As such, the tokenized account information can be stored and utilized by the non-compliant PCI loyalty system 104 without worry that account information, such as credit card data, will be lost, stolen, or misused.

After the account information is transformed into tokenized account data by way of the payment gateway's 110 account data tokenization service, the tokenized account data is communicated back to the loyalty system 104. At the loyalty system 104, the tokenized account data is associated with the loyalty account which the user created during enrollment into the loyalty program or during an update to their user profile. (Step 2010). In an exemplary embodiment, the loyalty account stores the tokenized account information along with other user information to complete the loyalty account enrollment information or user profile update.

In an exemplary embodiment, each time the user presents the account information at a point-of-loyalty system 106, the payment gateway 110 can tokenize the account data, such as credit card data, in the same manner that the account data was tokenized initially by the payment gateway 110. The payment gateway 110 can communicate the purchase date (i.e., transactional information), including the tokenized account data, to the loyalty system 104. The loyalty system 104, having received the tokenized account data from the payment gateway 110, can use the tokenized account data to query its database of tokenized account data to identify the loyalty account associated with the tokenized account data. Loyalty awards can then be posted and/or redeemed from the identified loyalty account.

In an exemplary embodiment, since the payment gateway 110 tokenizes the account information before communication to the loyalty system 104, and the tokenization of the account information is done by way of an approved one-way encryption algorithm such as MD5 so that the original account information cannot later be decrypted, the loyalty system does not need to be PCI compliant and/or otherwise be compliant to handle financial data such as credit card data. This allows the loyalty system 104 to use the tokenized account information to identify the user's loyalty account indirectly using the tokenized data, not the original account information. As such, account information such as credit card data can be used in a tokenized indirect manner with a loyalty system and the loyalty system does not need to be PCI compliant and/or otherwise compliant to handle and process financial data.

In an exemplary embodiment, the payment gateway 110 generates and/or otherwise provides the tokenized data unless there is a database match. Once the tokenized account information has been associated with the loyalty account and stored to the loyalty system 104, the method 2000 with respect to a user registering a new loyalty account at the loyalty system 104 is complete.

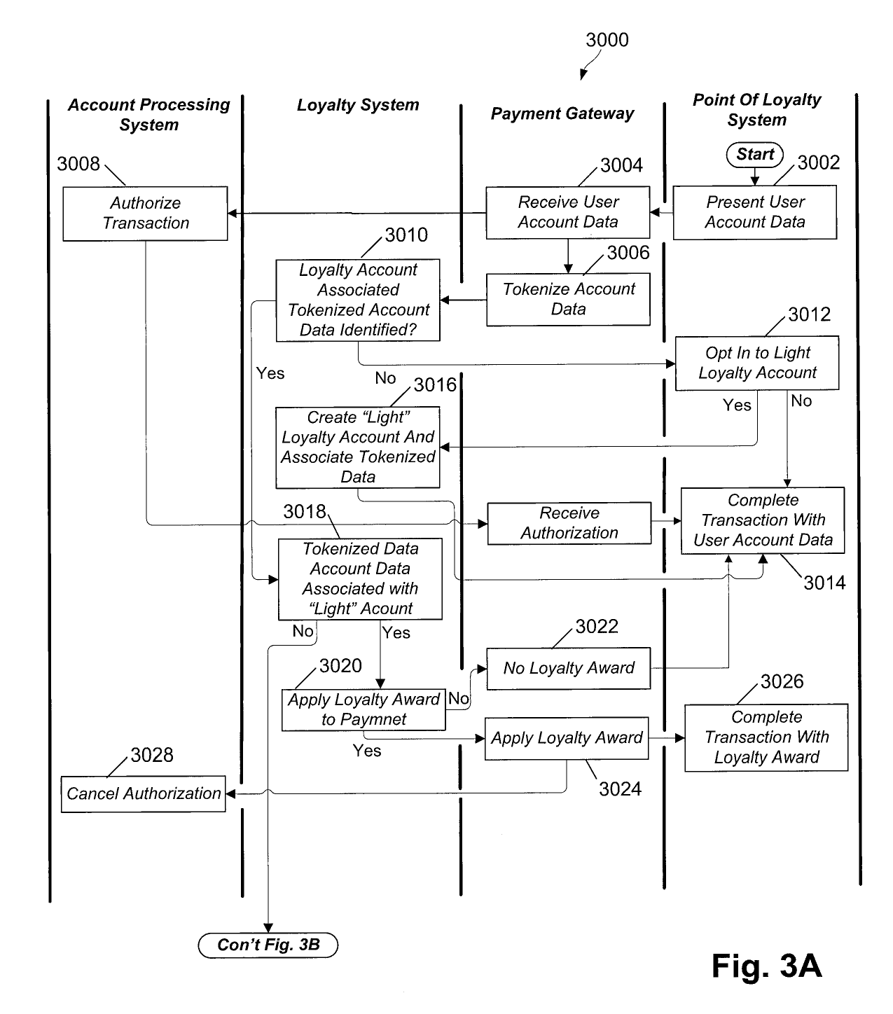

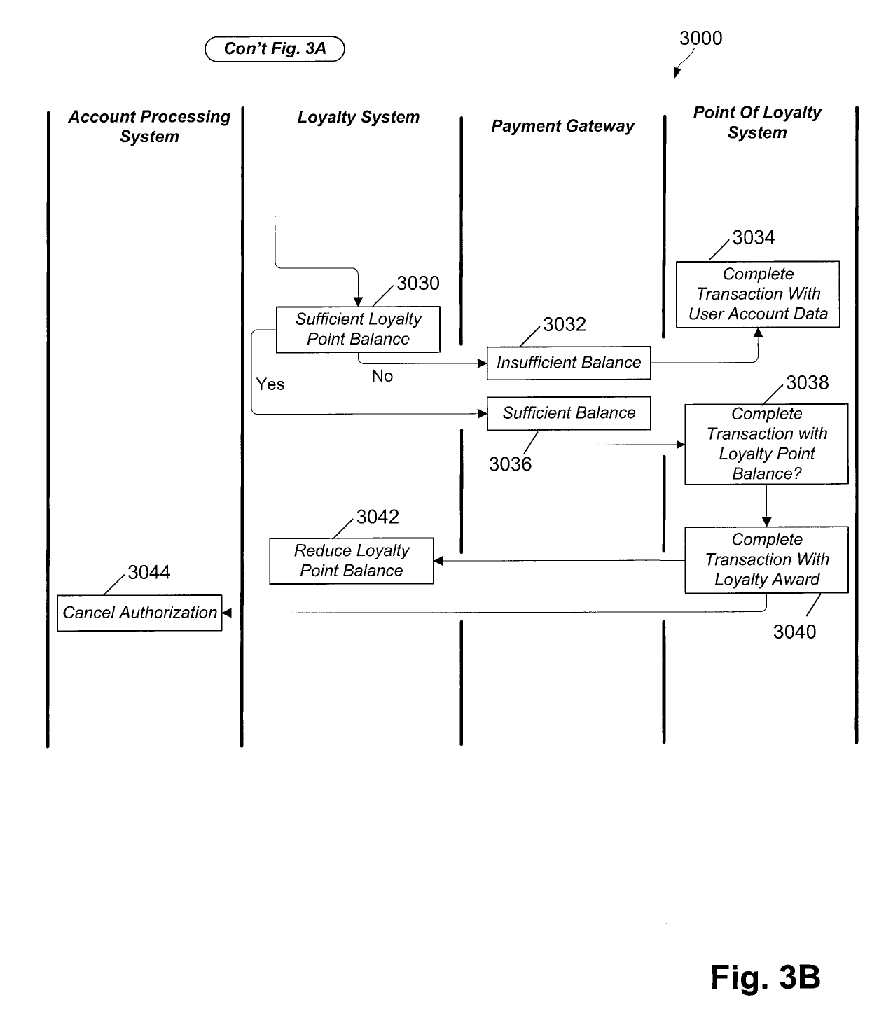

FIGS. 3A and 3B are flow charts depicting method 3000 of implementing a loyalty award program wherein a user accesses a point-of-loyalty system 106 to purchase goods or services. In an exemplary embodiment, when a user is at a point-of-loyalty system 106 and is ready to complete a transaction they can present the same account information, such as a credit card, for payment that they presented while enrolling in the loyalty program. It is also contemplated that a user can register different account information to the same loyalty awards account, i.e., the user can register different credit cards to the same loyalty award account. Alternatively, the user can register multiple loyalty award accounts using different account information, e.g., a user can have a different loyalty account corresponding to each of their credit card accounts. The account information cannot only be communicated to an account processing system 102 to pay for the goods or service but the account information can be tokenized and communicated to the loyalty system 104 to be used to look up a user's loyalty account and post or redeem loyalty awards. In an exemplary embodiment, the user may not have previously registered their account data with the loyalty system 104. When the user's account data is provided at the point-of-loyalty system 106, the user will be prompted to create a “light” version of their loyalty account including only their tokenized account information and the transaction information. The “light” loyalty account can be converted into a standard registered loyalty account when the user provides the necessary user information at the loyalty system 104, e.g., when the user completes the loyalty system's 104 web based enrollment form.

In an exemplary embodiment, purchase information related to the goods or services purchased (e.g., type, kind, amount, etc.) can be communicated with the tokenized account data to the loyalty system 104. The purchase information can be associated with the user in the loyalty system 104, and used to dynamically determine a loyalty award, for marketing or promotional purposes, to support a business partners marketing and/or promotional goals, and/or used in other purposes relevant to implementing a loyalty reward system. For example, a user can purchase a large COCA-COLA product at a quick serve restaurant. The user can present their account information in the form of a credit card for payment. Payment can be effectuated by way of the account processing system 102. The tokenized account information can be communicated with the purchase information (e.g., the fact that the user purchased a large COCA-COLA product at a specified quick service restaurant) to the loyalty system 104. The loyalty system 104 uses the tokenized account data to locate the user's account and then selectively post a loyalty award to the user's account. Such a loyalty award could be a fixed number of points for the purchase. In an alternate embodiment, the loyalty award amount it could be a varied number of points based on transaction information including, for example, the size of the product purchased, location of the purchase, quantity or volume of the product purchased, the frequency of user purchases of the same or different products, or any combination of these loyalty award options and/or other loyalty award options.

To begin the process of purchasing goods/services at a point-of-loyalty system 106, a user can provide account data to a point-of-loyalty system 106 for payment for goods or services. (Step 3002). The provided account data can be received at the payment gateway 110 (Step 3004) and tokenized to create tokenized account data. (Step 3006). In an exemplary embodiment, the account information can be tokenized by way of a one-way encryption algorithm such as MD5 hash, and/or other one-way encryption algorithms to insure that the account information is not compromised by inadvertent disclosure. The one-way encryption algorithm preserves the ability to uniquely identify the user's loyalty account with encrypted data but does not utilize the original account information.

The account data can be communicated from the payment gateway 110 to the account processing system 102 so that the payment can be authorized. (Step 3008). The authorized payment amount is not processed using the user's account data, rather the account processing system 102 confirms with a transaction bureau, such as a credit card processor, that the user's account is capable of the authorized payment amount.

The payment gateway 110 provides the tokenized account data to the loyalty system 104 to determine if there is an existing loyalty account associated with the tokenized data. (Step 3010). For example, the loyalty system 104 can compare the tokenized account data with stored tokenized account data associated with loyalty accounts maintained by the loyalty system 104. If no matching tokenized account data is found, the loyalty system 104 notifies the payment gateway 110 and the point-of-loyalty system 106. When no stored tokenized account data is found in the loyalty system 104, the point-of-loyalty system 106 may query the user as to whether they would like to create a new loyalty account. (Step 3012). In some embodiments the loyalty system 104 may first notify the payment gateway 110 that no matching loyalty accounts were found, and the payment gateway 110 may in turn notify the point-of-loyalty system 104 to query the user regarding creating a new loyalty account. If the user elects not to create a loyalty account, the process ends and the transaction is completed using the account data provided by the user. (Step 3014). If the user elects to create a loyalty account, the payment gateway 110 and the loyalty system 104 in turn, receive a message to create a “light” loyalty account in the loyalty system 104. (Step 3016). In an exemplary embodiment, the message from the payment gateway 110 to the loyalty system 104 to create the light loyalty account also includes the tokenized account data. Alternatively, because the loyalty system 104 has already received the tokenized account information (see Step 3010), the message from the payment gateway 110 to the loyalty system 104 may only include the instructions to create a new “light” loyalty account and not the tokenized account information. In an exemplary embodiment, the loyalty account is qualified as “light” because the only user-specific information included in the loyalty account is the tokenized account data and the purchase history associated with that tokenized account data.

Upon receiving the instructions to create a “light” loyalty account, the loyalty system 104 creates a loyalty account including a table associating the tokenized account data with the transaction information and/or other metrics used to track and award a loyalty reward to a user. The other award metrics can include, for example, awards provided in response to the purchase of a particular quantity or type product, a purchase at a particular location, completing various tasks associated with the loyalty program (sharing the loyalty program with friends, providing a rating/review of the loyalty program, post regarding the loyalty program on a social media site, etc.), and/or any other factors relevant to determining an award amount. In an exemplary embodiment, the table can associate the tokenized account data with the number of purchases made since the last loyalty award had be awarded to the use or since the use had created their “light” loyalty account. Once the account has been created, and because the “light” account is a new loyalty account where no loyalty awards have been accumulated, the transaction is completed using the account data provided by the user. (Step 3014).

Referring back to Step 3010 where the payment gateway 110 provides the tokenized account data to the loyalty system 104, if a the loyalty system 104 determines that an existing loyalty account is associated with the tokenized account data, the loyalty system 106 next determines what type of loyalty account is associated with the tokenized account data. (Step 3018). If the loyalty account is a light account, the loyalty system 104 then determines if the loyalty awards associated with the account indicate that the loyalty award should be applied in the transaction at the point-of-loyalty 106. (Step 3020). If the loyalty awards associated with the light account indicate that the user does not have sufficient quantity of awards to complete the transaction without providing payment, an award is not used to complete the transaction and the loyalty system 104 can send a message to the payment gateway 110 not to apply a loyalty award to the transaction. (Step 3022). The payment gateway 110 may then send a message to the point-of-loyalty system 106 to complete the transaction using the account data. (Step 3014).

If the loyalty awards associated with the light account indicate that the user has sufficient quantity of awards to complete the transaction without providing payment, the loyalty system 104 sends a message to the payment gateway 110 regarding the availability to complete the transaction using the loyalty award amount. (Step 3024). The payment gateway 110 may then communicate a message to the point-of-loyalty system 106 regarding the availability to complete the transaction using the loyalty award amount. (Step 3026). For example, the payment gateway 110 may communicate the tokenized account data and an indication of the award amount (e.g., a free beverage) with the message to the point-of-loyalty system 106. The user may be queried to determine if they'd like to user their award amount to in lieu of payment. For example, the user may be queried at the point-of-loyalty system 106 whether they want to apply their accrued award to complete the transaction using their loyalty award. If the user agrees to use the loyalty award amount in lieu of the account data to effectuate payment, the point-of-loyalty system 106 may complete the transaction with the loyalty award. (Step 3026). In an exemplary embodiment, the point-of-loyalty system 106 can store the tokenized account information along with the transaction information for auditing and reconciliation purposes. Upon applying the loyalty award to effectuate payment, the payment gateway 110 may also send a message to the account processing system 102 to cancel the credit card authorization. (Step 3028). In some embodiments the user may not be queried to determine if they'd like to user their award amount to in lieu of payment. Rather, in such embodiments, the award amount is automatically applied, if available, to complete the transaction.

Continued in FIG. 3B, if the type of account is a registered loyalty account, the loyalty system 104 can determine if the loyalty account has a sufficient loyalty award amount to complete the transaction. (Step 3030). In an exemplary embodiment, the loyalty account can be queried and the user's the award total can be retrieved to determine if the user's loyalty award total is sufficient to complete the transaction at the point-of-loyalty system 106. Should the award account include insufficient balance to complete the transaction using the loyalty award, the loyalty system 104 can send a message to the payment gateway 110 that there is insufficient loyalty award amount to complete the transaction. (Step 3032). The payment gateway 110 may then send a message to the point-of-loyalty system 106 to complete the transaction using the account data. (Step 3034). The message to the point-of-loyalty system 106 can also include instructions to display to the user their current loyalty award balance. The message to the point-of-loyalty system 106 may also include a user query regarding whether the user would like to complete the transaction using the user account data. If the user selects to complete the transaction using the user account data, the point-of-loyalty system 106 can send a message to the payment gateway 110 to complete the transaction using the user account data. The payment gateway 110 can then send a message to the account processing system 102 to complete the transaction using the user account data. Alternatively, if the user declines to complete the transaction using the account data, the point-of-loyalty system 106 can send a message to the payment gateway 110 indicating that the transaction has been cancelled. The payment gateway 110 may, in turn, send a message to the account processing system 102 to cancel the credit card authorization.

Should the award account include a sufficient balance to complete the transaction using the loyalty award, the loyalty system 104 can send a message to the payment gateway 110 that there is sufficient loyalty award amount to complete the transaction. (Step 3036). The message to the payment gateway 110 can include the tokenized account information and any other indication that the transaction can be completed using loyalty points. The message can also include a current award total or loyalty point balance. The payment gateway 110 can then send a message to the point-of-loyalty system 106 indicating that the transaction can be completed using loyalty points and passing along the loyalty points balance, if provided. The point-of-loyalty system 106 can then send query the user regarding whether the user would like to complete the transaction using the loyalty award. (Step 3038). This user query can include the loyalty point balance, if provided.

If the user selects to complete the transaction using their loyalty points, the point-of-loyalty system 106 may send a message to the payment gateway 110 to complete the transaction using loyalty points. (Step 3040). The payment gateway 110 may also send a message to the loyalty system 104 to adjust the award balance in the award account to according to the loyalty points purchase amount, i.e., adjust the loyalty point balance a sufficient amount to pay for the transaction. (Step 3042). The payment gateway 110 may, in turn, send a message to the account processing system 102 to cancel the credit card authorization. The loyalty system 104 may send a confirmation message back to the payment gateway 110 indicating that the loyalty point balance has been reduced to pay for the transaction and optionally include the new loyalty amount balance. The payment gateway 110 may pass along the confirmation message to the point-of-loyalty system 106. In an exemplary embodiment, the point-of-loyalty system 106 is a vending machine. A selected product may be vended upon receiving input from the user to pay with loyalty points. In an alternate embodiment, the product may not be vended until receiving the confirmation message from the payment gateway 110 indicating that the loyalty point balance of the registered loyalty account has been reduced in accordance with the purchase amount.

If the user declines to complete the transaction using their loyalty points, the user may be queried to complete the transaction using the user account data. If the user then selects to complete the transaction using their user account data, the point-of-loyalty system 106 can send a message to the payment gateway 110 to complete the transaction using the user account data. The payment gateway 110 can then send a message to the account processing system 102 to complete the transaction using the user account data. However, if the user declines to complete the transaction using either their loyalty points or their account information, the point-of-loyalty system 106 can send a message to the payment gateway 110 indicating that the transaction has been cancelled. The payment gateway 110 may, in turn, send a message to the account processing system 102 to cancel the credit card authorization. (Step 3044).

In an exemplary embodiment, any time the user completes a transaction, whether using their user account data or a loyalty award amount, loyalty awards can be posted to the user's loyalty award account. In an alternate embodiment, only when the user utilizes their user account data to complete a transaction are loyalty awards posted to their loyalty award account. The payment gateway 110, upon confirmation that the transaction is complete from either of the account processing system 102 or the point-of-loyalty 106, can send a message to the loyalty system 104 to post the award amount to the user's loyalty award account. Such loyalty posting can be a fixed number of points, a dynamic number of points, and/or other types and kinds of awards and point determination methods, as may be required and/or desire in a particular embodiment.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although the present invention is described with reference to exemplary embodiments, it should be appreciated by those skilled in the art that various modifications are well within the scope of the invention. From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the exemplary embodiments, equivalents of the elements shown therein will suggest themselves to those skilled in the art, and ways of constructing other embodiments of the present invention will suggest themselves to practitioners of the art. Therefore, the scope of the present invention is not limited herein.

What is claimed is:

1. A computer implemented method of implementing a loyalty awards program in a loyalty system, the method comprising:
presenting, at a user interface, a loyalty program enrollment form for receiving data from a user,
receiving user data associated with the enrollment form;
creating a loyalty account based on the user data;
receiving tokenized account data associated with the user; and
associating the tokenized account data with the loyalty account.

2. The method of claim 1,
wherein the loyalty program enrollment form includes an account input field for receiving the tokenized account data.

3. The method of claim 1, further comprising:
receiving transaction information corresponding to a purchase event completed by the user.

4. The method in accordance with claim 3, further comprising:
posting a loyalty award to the loyalty account in response to the transaction information.

5. The method of claim 1, further comprising:
receiving a second tokenized account data.

6. The method of claim 5, further comprising:
comparing the second tokenized account data with a plurality of the tokenized account data stored at the loyalty system; and
creating a second loyalty account for a second user using the second tokenized account data.

7. The method in accordance with claim 6, further comprising:
receiving transaction information corresponding to a purchased event completed by the second user.

8. The method in accordance with claim 1, wherein the tokenized account data is plurality of a credit card data.

9. A computer implemented method of implementing a loyalty awards program, the method comprising:
receiving a tokenized account data;
identifying a loyalty account associated with a user based on the tokenized account data;
determining an loyalty award balance of the loyalty account;
receiving a purchase request corresponding to an attempted user purchase event;
comparing the loyalty award balance to the purchase request to authorize a payment of a first loyalty award amount; and
posting a loyalty award amount to the loyalty account.

10. The method of claim 9, further comprising
authorizing payment of the first loyalty award amount when the loyalty award balance is greater than the purchase request; and
deducting a second loyalty award from the loyalty award balance when payment of the loyalty award amount is confirmed, the second loyalty award amount corresponding to the purchase request.

11. The method of claim 9, further comprising
declining payment of the first loyalty award amount when the loyalty award balance is less than the purchase request;
wherein the account data is processed to authorize a payment corresponding to the purchase request when the first loyalty award amount is not applied to the payment.

12. The method of claim 9, wherein the loyalty account is identified based on comparison of the tokenized account data with a plurality of other tokenized account data stored at the loyalty system.

13. The method in accordance with claim 9, further comprising:
presenting a loyalty program enrollment form for receiving user data associated with the loyalty account, the loyalty program enrollment form including an account input field for receiving the tokenized account data.

14. The method in accordance with claim 13, further comprising:
receiving a second tokenized account data; and
associating the second tokenized account data with the loyalty account.

15. A computer implemented method of implementing a loyalty awards program, the method comprising:
receiving a tokenized account data;
searching a plurality of loyalty accounts at the loyalty system to identify a loyalty account associated with the tokenized account data; and
creating a first loyalty account based on the tokenized account data when the loyalty account associated with the tokenized account data is not included in the loyalty system.

16. The method of claim 15, further comprising:
receiving user data;
associating the user data with the first loyalty account.

17. The method of claim 16, further comprising:
receiving transaction information associated with a tokenized account data; and
posting a loyalty award to the first loyalty account based on the transaction information.

18. The method in accordance with claim 15, further comprising:
receiving a second tokenized account data;
searching the plurality of loyalty accounts at the loyalty system to identify a loyalty account associated with the second tokenized account data; and
creating a second loyalty account based on the tokenized account data when the loyalty account associated with the second tokenized account data is not included in the loyalty system;
receiving a second transaction information associated with a second tokenized account data; and
posting a loyalty award to the second loyalty account based on the second transaction information.

19. The method in accordance with claim 15, further comprising:
wherein the first loyalty account is associated with a user;
receiving a third tokenized account data; and
associating the third tokenized account data with the first loyalty account when the third tokenized account data is associated the user.

20. The method in accordance with claim 15, wherein the first loyalty account is created in response to a user request.

21. A computer implemented method for processing a loyalty award transaction comprising:
receiving user account data from a transaction device;
providing the account data to an account processing system;
tokenizing the user account data to create a tokenized user account data;
providing the tokenized user account data to a loyalty system;
providing instructions to a transaction device to complete a transaction;
wherein the transaction is completed using at least one of the user account data and a loyalty award amount.
